(19) United States
(12) Patent Application Publication
(10) Pub. No.: US 2026/0002338 A1
(43) Pub. Date: Jan. 1, 2026

(54) Adaptive Spin Control System and Method for Construction Machine

(71) Applicant: DEERE & COMPANY, Moline, IL (US)

(72) Inventors: Doug M. Lehmann, Durango, IA (US); Ryan N. Detweiler, Peosta, IA (US)

(21) Appl. No.: 18/754,260

(22) Filed: Jun. 26, 2024

(51) Int. Cl. E02F 9/20; E02F 9/26

(52) U.S. Cl. CPC E02F 9/2079; E02F 9/26

(57) ABSTRACT

A work machine for loading material in a worksite includes a power source configured to provide torque, a ground engaging mechanism configured rotate to move the work machine along a ground surface using torque from the power source. A controller is configured to receive a first signal indicative of a speed of the work machine moving along the ground surface and a second signal indicative of a rotational speed of the ground engaging mechanism, and the controller is configured to adjust the torque delivered to the ground engaging mechanism based on the first signal and the second signal, for example, by setting a maximum for an amount of torque to be delivered to the ground engaging mechanism or by sending a signal to the power source or a drivetrain coupled to the power source to change the amount of torque output by the power source or the drivetrain.

### FIELD OF THE DISCLOSURE

The present disclosure relates to a control system for a construction machine, and more particularly, to a control system for adjusting torque delivery of the construction machine.

### BACKGROUND OF THE DISCLOSURE

Various work machines or vehicles, for example those configured to load and unload material in construction operations use a power source to provide torque ultimately to wheels or tracks. Such machines often experience slippage or spinning of the wheels or tracks, which may damage the wheels or tracks or material being handled by the work machine.

### SUMMARY

In an illustrative embodiment, a work machine for loading material in a worksite comprises: a power source configured to provide torque; a ground engaging mechanism configured to rotate to move the work machine along a ground surface; a drivetrain coupled to the power source and to the ground engaging mechanism, the drivetrain configured to deliver torque from the power source to the ground engaging mechanism to drive rotation of the ground engaging mechanism; a work machine speed sensor configured to measure the speed of the work machine moving along the ground surface; a wheel speed sensor configured to measure the rotational speed of the ground engaging mechanism; a controller operatively coupled to the wheel speed sensor and the work machine speed sensor and configured to receive a first signal from the work machine speed sensor indicative of the speed of the work machine moving along the ground surface and a second signal from the wheel speed sensor indicative of the rotational speed of the ground engaging mechanism; wherein the controller is configured to adjust the torque delivered to the ground engaging mechanism based on the first signal and the second signal.

In some embodiments, the controller is configured to set a maximum value for the torque delivered to the ground engaging mechanism based on the first signal and the second signal. In some embodiments, the controller is configured to compare a sensed ratio, which is comprised of the first signal relative to the second signal, to an expected ratio; and wherein if a difference between the expected ratio and the sensed ratio exceeds an established value, the controller is configured to set a maximum value for the torque delivered to the ground engaging mechanism. In some embodiments, the maximum value for the torque delivered to the ground engaging mechanism is less than the amount of torque being delivered to the ground engaging mechanism when the difference between the expected ratio and the sensed ratio exceeds the established value.

In some embodiments, the work machine further comprises: a location sensor operatively coupled to the controller; wherein the location sensor is configured to send one or more third signals to the controller indicative of the location of the work machine in the worksite. In some embodiments, the controller is configured to adjust the torque delivered to the ground engaging mechanism based on the one or more third signals.

In some embodiments, the controller is configured to compare a sensed ratio, which is comprised of the first signal relative to the second signal, to an expected ratio; and if a difference between the expected ratio and the sensed ratio exceeds an established value, the controller is configured to set, for the location of the work machine in the worksite, a maximum value for the torque delivered to the ground engaging mechanism.

In some embodiments, the controller is configured to compare a sensed ratio, which is comprised of the first signal relative to the second signal, to an expected ratio; and if a difference between the expected ratio and the sensed ratio exceeds an established value, the controller is configured to designate, as a slip zone, the location of the work machine in the worksite. In some embodiments, the controller is configured to compare the location of the work machine to the slip zone to determine when the work machine is in the slip zone; and the controller is configured to adjust the torque delivered to the ground engaging mechanism in response to determining that the work machine is in the slip zone. In some embodiments, the controller is configured to decrease the torque delivered to the ground engaging mechanism in response to determining that the work machine is in the slip zone. In some embodiments, the controller is configured to decrease the torque delivered to the ground engaging mechanism based on the first signal and the second signal.

In some embodiments, the controller is configured to adjust the torque delivered to the ground engaging mechanism by a first amount in response to determining that the work machine is in the slip zone; the controller is configured to determine that the work machine is in the slip zone an additional time based on the one or more third signals; and the controller is configured to adjust the torque delivered to the ground engaging mechanism by an amount lesser than the first amount in response to determining that the work machine is in the slip zone an additional time. In some embodiments, in response to determining that the work machine is in the slip zone an additional time, the controller is configured to decrease the torque delivered to the ground engaging mechanism to adjust the torque delivered to the ground engaging mechanism by the amount lesser than the first amount. In some embodiments, in response to determining that the work machine is in the slip zone an additional time, the controller is configured to increase the torque delivered to the ground engaging mechanism to adjust the torque delivered to the ground engaging mechanism by the amount lesser than the first amount.

In some embodiments, the controller is configured to compare a sensed ratio, which comprises a measured speed of the work machine moving along the ground surface relative to a measured rotational speed of the ground engaging mechanism, to an expected ratio; if a difference between the expected ratio and the sensed ratio exceeds an established value, the controller is configured to designate, as a slip zone, a current location of the work machine in the worksite; and each additional time the work machine is in the slip zone, the controller is configured to compare the sensed ratio to the expected ratio.

In another illustrative embodiment, a work machine for loading material in a worksite comprises: a power source configured to provide torque; a ground engaging mechanism configured to rotate to move the work machine along a ground surface; a drivetrain coupled to the power source and to the ground engaging mechanism, the drivetrain configured to deliver torque from the power source to the ground engaging mechanism to drive rotation of the ground engaging mechanism; a work machine speed sensor configured to measure the speed of the work machine moving along the ground surface; a wheel speed sensor configured to measure the rotational speed of the ground engaging mechanism; and a controller operatively coupled to the wheel speed sensor and the work machine sensor and configured to receive a first signal from the work machine speed sensor indicative of the speed of the work machine moving along the ground surface and a second signal from the wheel speed sensor indicative of the rotational speed of the ground engaging mechanism; wherein the controller is configured to set a maximum value for the torque delivered to the ground engaging mechanism based on the first signal and the second signal.

In some embodiments, the controller is configured to compare a sensed ratio, which is comprised of the first signal relative to the second signal, to an expected ratio; and if a difference between the expected ratio and the sensed ratio exceeds an established value, the controller is configured to set, for a current location of the work machine in the worksite, the maximum value for the torque delivered to the ground engaging mechanism. In some embodiments, the maximum value for the torque delivered to the ground engaging mechanism is less than the torque delivered to the ground engaging mechanism when the difference between the expected ratio and the sensed ratio exceeds the established value.

In another illustrative embodiment, a method of adjusting torque of a work machine used for loading material in a worksite comprises: measuring a speed of the work machine moving along a ground surface; measuring a rotational speed of a ground engaging mechanism configured to move the work machine along the ground surface; receiving, via a controller, a first signal indicative of the speed of the work machine moving along the ground surface and a second signal indicative of the rotational speed of the ground engaging mechanism; adjusting, via the controller, a torque delivered to the ground engaging mechanism based on the first signal and the second signal.

In some embodiments, the method further comprises: measuring a location of the work machine in the worksite; receiving, via the controller, a third signal indicative of the location of the work machine in the worksite; and adjusting the torque delivered to the ground engaging mechanism further based on the third signal.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a work machine;

FIG. 2 is a schematic diagram of a control system for the work machine of FIG. 1;

FIG. 3 is a flow diagram of an exemplary method for adjusting torque and setting a maximum value for an amount of torque delivered to ground engaging mechanisms of the work machine;

FIG. 4 is a flow diagram of further exemplary steps of the method of FIG. 3.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

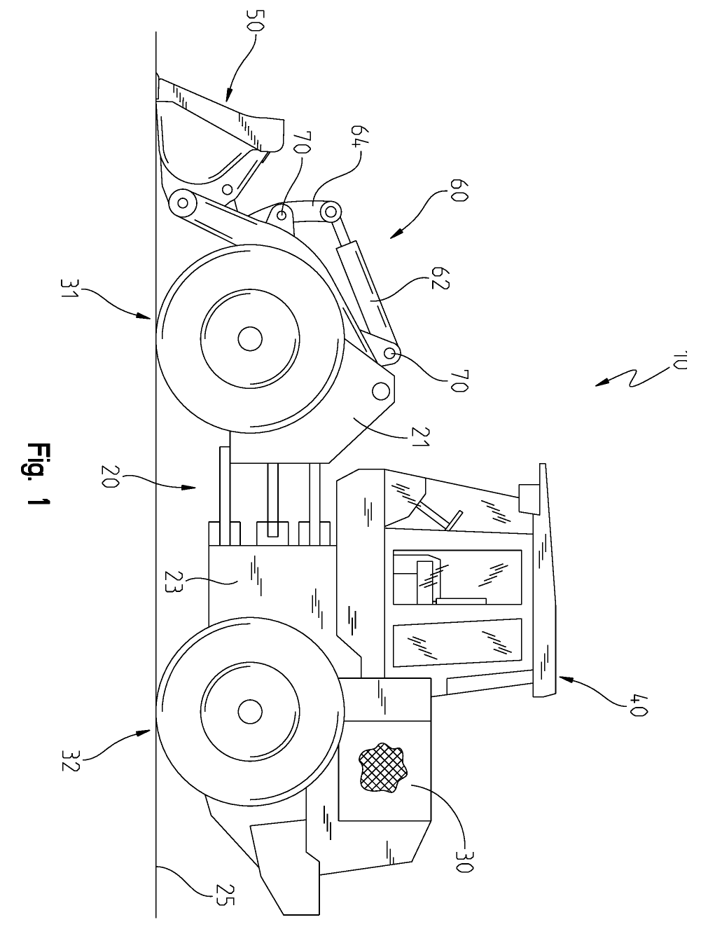

Referring to FIG. 1, an exemplary work machine 10 is shown. In the illustrative embodiment, the work machine 10 includes a chassis 20 that cooperates with front and rear ground engaging mechanisms 31, 32 to support a power source 30 above a ground surface 25. In the illustrative embodiment, the ground engaging mechanisms 31, 32 include a first set of wheels (e.g., tires) coupled to a front portion 21 of the chassis 20 and a second set of wheels (e.g., tires) coupled to a rear portion 23 of the chassis 20. In other embodiments, the ground engaging mechanisms 31, 32 may include tracks, for example. The ground engaging mechanisms 31, 32 are configured to rotate to move the work machine 10 along the ground surface 25, for example, during a construction operation on a worksite. In some embodiments, the front portion 21 of the chassis 20 may articulate relative to the rear portion 23 of the chassis 20 to guide the direction of movement of the work machine 10.

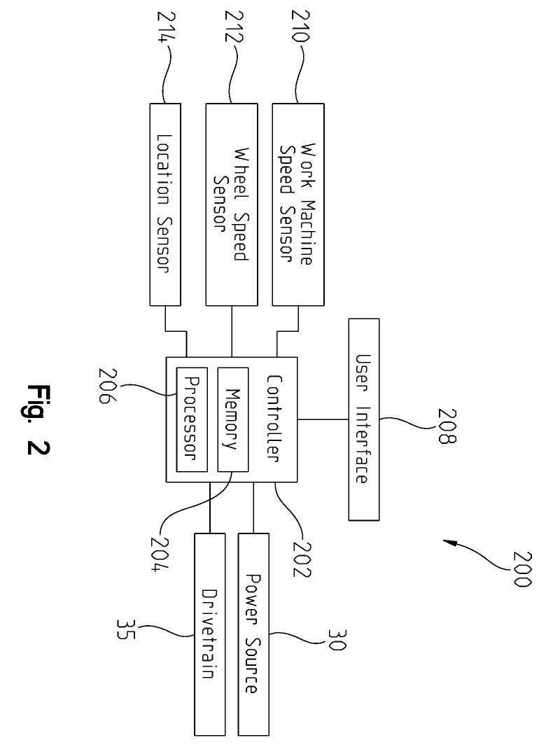

The power source 30 may be an engine such as, for example, a diesel, gasoline, or other type of engine, a motor (e.g., electric), or another prime mover sufficient to propel the ground engaging mechanisms 31, 32 to cause movement of the work machine 10 along the ground surface 25. In the illustrative embodiment, the power source 30 is configured to provide torque to drive rotation of the ground engaging mechanisms 31, 32 along the ground surface 25. In the illustrative embodiment, the work machine 10 includes a drivetrain 35 (see FIG. 2) coupled to the power source 30 and the ground engaging mechanisms 31, 32, and the drivetrain 35 is configured to drive rotation of the ground engaging mechanisms 31, 32 using torque output from the power source 30. For example, the power source 30 delivers torque to the drivetrain 35, which delivers torque to the ground engaging mechanisms 31, 32 causing rotation thereof. In some embodiments, each wheel of the ground engaging mechanisms 31, 32 receives equal torque output from the drivetrain 35, and in some embodiments, different wheels (e.g., right versus left and/or front versus rear) of the ground engaging mechanisms 31, 32 receive different torque output from the drivetrain 35.

In the illustrative embodiment, the work machine 10 further includes an operator cab 40, a work implement 50, and a boom 60. In the illustrative embodiment, the work implement 50 is a bucket, which is coupled to the chassis 20 of the work machine 10 by the boom 60. In the illustrative embodiment, the boom 60 includes one or more boom actuators 62, and a boom linkage 64. The work machine 10 may also include one or more implement actuators. In the illustrative embodiment, the one or more implement actuators and the one or more boom actuators 62 are configured to extend and retract to cause movement of the work implement 50 to load and unload material (e.g., soil, rock, debris) in a worksite during a construction operation. While the work machine 10 is shown in FIG. 1, it should be appreciated that the disclosure herein (e.g., the disclosure directed to setting or adjusting torque values based on sensed parameters) is not limited to the work machine 10 and is applicable to various work machines, especially those usable in construction operations to load and unload material.

Referring now to FIG. 2, in the illustrative embodiment, the work machine 10 includes a control system 200 including at least one work machine speed sensor 210 configured to measure the speed of the work machine 10, for example, as the work machine 10 moves along the ground surface 25. The at least one work machine speed sensor 210 may be embodied as radar sensor, LIDAR sensor, hall effect sensor, or any other type of sensor suitable for measuring the speed of the work machine 10 moving relative to a fixed location, such as the ground surface 25. In the illustrative embodiment, control system 212 also includes at least one wheel speed sensor 212 configured to measure the rotational speed of one or more ground engaging mechanisms 31, 32 of the work machine 10. It should be appreciated that the at least one wheel speed sensor 212 may be used to measure the rotational speed of each wheel individually, a subset of wheels, or all wheels (or other ground engaging mechanisms) of the work machine 10. The at least one wheel speed sensor 212 may be embodied as a hall effect sensor or any other type of sensor suitable for measuring the rotational speed of the one or more ground engaging mechanisms 31, 32. In the illustrative embodiment, control system 200 also includes a location sensor 214 configured to measure the location of the work machine 10, for example, in the worksite in which the work machine 10 is operating. The location sensor 214 may be a Global Navigation Satellite System (GNSS) sensor, a Global Positioning System (GPS) sensor, or any other type of sensor suitable for measuring the location of the work machine 10, for example, in the worksite.

Referring still to FIG. 2, the control system 200 includes a controller 202, one or more memories 204 included in or accessible by the controller 202, and one or more processors 206 included in or accessible by the controller 202. The one or more processors 206 are configured to execute instructions (e.g., one or more algorithms) stored on the one or more memories 204. The controller 202 may be a single controller or a plurality of controllers operatively coupled to one another. The controller 202 may be positioned on the work machine 10 or positioned remotely, away from the work machine 10. The controller 202 may be coupled via a wired connection or wirelessly to other components of the work machine 10 and to one or more remote devices. In some instances, the controller 202 may be connected wirelessly via Wi-Fi, Bluetooth, Near Field Communication, or another wireless communication protocol to other components of the work machine 10 and to one or more remote devices.

In the illustrative embodiment, the controller 202 is operatively coupled to the at least one work machine speed sensor 210, the at least one wheel speed sensor 212, the location sensor 214, a user interface 208, and at least one of the power source 30 and the drivetrain 35. In the illustrative embodiment, the user interface is configured to provide information, e.g., input by a user via the user interface 208, to the controller 202. In some embodiments, the user interface 208 may include a display, audio output, or haptic elements, configured to output information received from the controller 202 to a user. As described in the exemplary methods 300, 400, in some embodiments, the controller 202 is configured to adjust the amount of torque output by the power source 30, the drivetrain 35, or both based on signals received from the sensors 210, 212, 214. In some embodiments, such adjustment is achieved by first setting a maximum value for an amount of torque output by the power source 30, the drivetrain 35, or both (i.e., delivered to the ground engaging mechanisms 31, 32) based on signals received from the sensors 210, 212, 214. In other embodiments, the controller 202 sends a signal to the power source 30, the drivetrain 35, or both to immediately adjust the torque output (without first setting a maximum torque) based on signals received from the sensors 210, 212, 214.

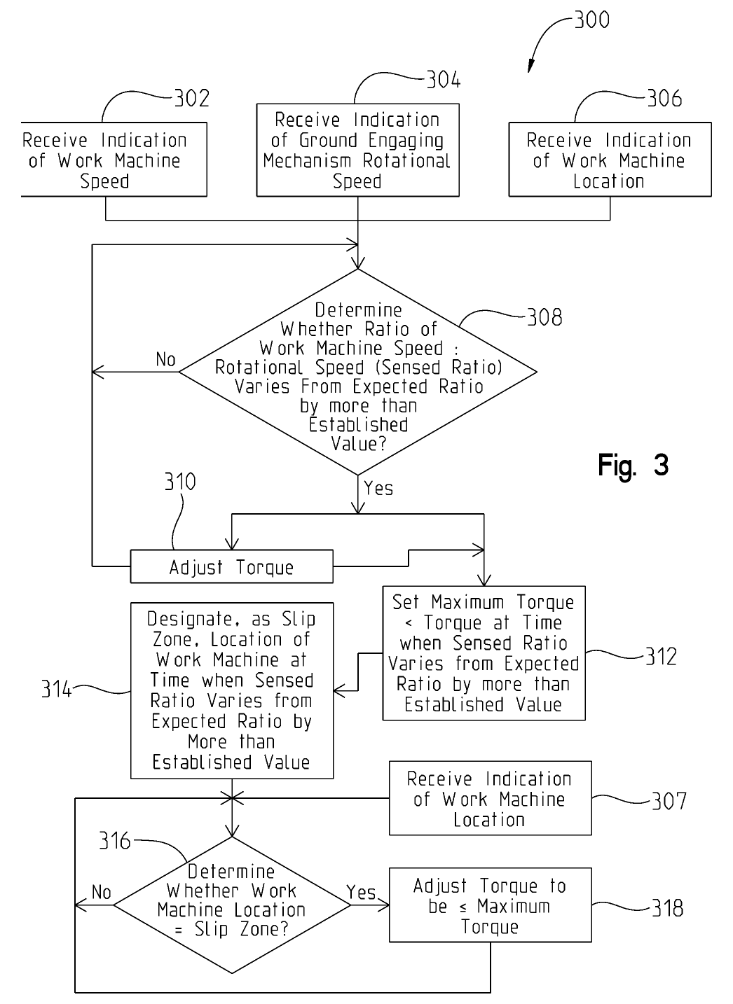

Referring now to FIG. 3, an exemplary method 300 is shown for adjusting the torque and/or setting a maximum torque that is delivered to the ground engaging mechanisms 31, 32. In the illustrative embodiment, at a block 302, the controller 202 receives (from the at least one work machine speed sensor 210) an indication of the speed of the work machine 10, for example, traveling along the ground surface 25. This indication may be referred to as a first signal. In the illustrative embodiment, at a block 304, the controller 202 receives (from the at least one wheel speed sensor 212) an indication of the rotational speed of at least one ground engaging mechanism 31, 32. This indication may be referred to as a second signal. It should be appreciated that the second signal may comprise the rotational speed of a single ground engaging mechanism (e.g., a single wheel), a subset of thereof, or all ground engaging mechanisms 31, 32. In some embodiments, the controller 202 may determine the average rotational speed of the ground engaging mechanisms 31, 32 based on the second signal. In the illustrative embodiment, at a block 306, the controller 202 receives (from the at least one location sensor 214) an indication of the location (e.g., current location) of the work machine 10, such as the location of the work machine 10 within the worksite. The indication may be referred to as a third signal. In some embodiments, the controller 202 receives the current location of the work machine 10 at multiple times, in which case the indications may be referred to as one or third signals.

Referring still to FIG. 3, at a block 308, the controller 202 is configured to compare a sensed ratio to an expected ratio. In the illustrative embodiment, the sensed ratio comprises a ratio of the first signal (i.e., measured speed of the work machine 10) relative to the second signal (i.e., measured rotational speed of the ground engaging mechanisms 31, 32), and the expected ratio comprises an expected ratio of the speed of the work machine 10 at a given rotational speed of the ground engaging mechanism 31, 32. These values may be determined outside the methods 300, 400 for a given work machine or type of work machine or they may be calibrated (i.e., initialized) during a work operation. In the illustrative embodiment, the expected ratio may be stored on the memory 204 and/or provided to the controller 202 by the user interface 208. To that end, at the block 308, the controller 202 determines whether the sensed ratio varies from the expected ratio by more than an established value. In the illustrative embodiment, the established value may be stored on the memory 204 and/or provided to the controller 202 by the user interface 208.

Referring still to FIG. 3, in some embodiments, the method 300 proceeds to the block 310. At the block 310, in response to determining that the sensed ratio varies from the expected ratio by more than the established value, the controller 202 sends a signal to at least one of the power source 30 and the drivetrain 35 to adjust the torque delivered to the ground engaging mechanisms 31, 32. This is an example of the controller 202 adjusting the torque delivered to the ground engaging mechanisms 31, 32 based on the first signal and the second signal.

In some embodiments, the controller 202 causes adjustment of the torque delivered to the ground engaging mechanism 31, 32 in a different manner. For example, the method 300 may proceed from the block 308 to the block 312. At the block 312, in response to determining that the sensed ratio varies from the expected ratio by more than the established value, the controller 202 sets a maximum value for an amount of torque to be delivered to the ground engaging mechanisms 31, 32. For example, the controller 202 may set a maximum value for an amount of torque output by the power source 30, a maximum value for an amount of torque output by the drivetrain 35, or both. This is an example of the controller 202 causing torque adjustment by setting a maximum value for the torque delivered to the ground engaging mechanisms 31, 32 based on the first signal and the second signal. It should appreciated that the maximum value for the amount of torque delivered to the ground engaging mechanisms is set at value less than the amount of torque delivered to the ground engaging mechanisms 31, 32 when the controller 202 determines that the sensed ratio varies from the expected ratio by more than the established value.

Through the process described, the controller 31, 32 identifies slippage or spinning of the ground engaging mechanisms 31, 32 and sets a torque limit to prevent future slippage or spinning. Therefore, the location of the work machine 10 at the time of the slippage or spinning must be identified so that the torque limit can be applied for work machine 10 when the work machine 10 is in the location where the original slippage or spinning occurred. Thus, in some embodiments, at a block 314, the controller 202 designates as a “slip zone” the location of the work machine 10 at the time when controller 202 determines that the sensed ratio varies from the expected ratio by more than the established value.

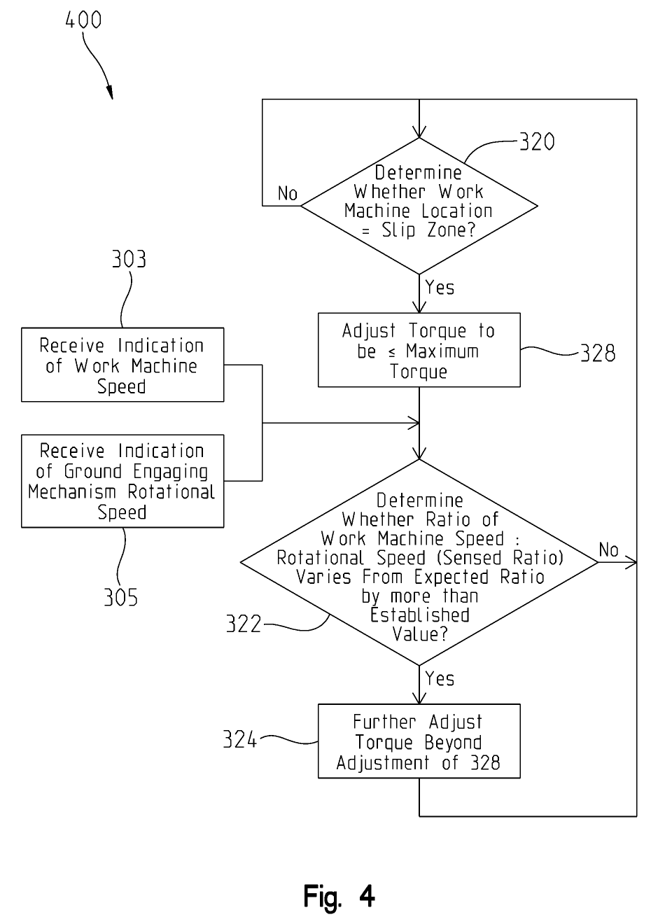

In some embodiments, the controller 202 is continuously, or at regular intervals, receiving indications of the speed of the work machine 10, the rotational speed of the ground engaging mechanisms 31, 32, and/or the location of the work machine 10. In other embodiments, the controller 202 queries the sensors 210, 212, 214 to request such information at the appropriate time(s) according to the algorithms of FIGS. 3-4.

In the illustrative embodiment shown in FIG. 3, at a block 307, the controller 202 receives another indication of the location of the work machine 10. Referring still to FIG. 3, at a block 316, the controller 202 is configured to compare the location of the work machine 10 (as received via the block 307) to the location of the slip zone. To that end, at the block 316, the controller 202 determines whether the work machine 10 is within the slip zone. In the illustrative embodiment, at a block 318, if the work machine 10 is within the slip zone, the controller 202 is configured to compare the torque delivered to the ground engaging mechanisms 31, 32 to the maximum torque value, and if the torque delivered to the ground engaging mechanisms 31, 32 is not less than or equal to the maximum torque value, the controller 202 adjusts (i.e., decreases) the torque delivered to the ground engaging mechanisms 31, 32 to be less than or equal to the maximum torque value. This is example of the controller 202 adjusting the torque delivered to the ground engaging mechanisms 31, 32 based on the one or more third signals (in additional to the first and second signals).

Referring now to FIG. 4, a method 400 is shown, which includes further steps for adjusting the torque and/or setting the maximum torque delivered to the ground engaging mechanisms 31, 32. Subsequent to designating the slip zone, the algorithm may proceed to the block 320. At the block 320, the controller 202 determines that the work machine 10 is in the slip zone an additional time based on the one or more third signals. For example, the controller 202 compares the location of the slip zone to the current location of the work machine 10 received from the location sensor 214 to determine that the work machine 10 is within the slip zone. In response to determining that the work machine 10 is within the slip zone, at a block 328 the controller 202 is configured to compare the torque delivered to the ground engaging mechanisms 31, 32 to the maximum torque value, and if the torque delivered to the ground engaging mechanisms 31, 32 is not already less than or equal to the maximum torque value, the controller 202 adjusts (i.e., decreases) the torque delivered to the ground engaging mechanisms 31, 32 to be less than or equal to the maximum torque value. Further, upon determining that the work machine 10 is within the slip zone, the controller 202 receives an indication (via block 303) of the speed of the work machine 10 and an indication (via block 305) of the rotational speed of the ground engaging mechanisms 31, 32.

Referring still to FIG. 4, at the block 322, the controller 202 determines whether a sensed ratio (comprised of the work machine speed received via block 305 relative to the rotational speed of the ground engaging mechanisms received via block 307) varies from the expected ratio by more than the established value. In the illustrative embodiment, at a block 324, in response to determining that the sensed ratio varies from the expected ratio by more than the established value, the controller 324 further adjusts the torque delivered to the ground engaging mechanisms 31, 32 beyond the adjustment made in block 328. Thus, in other words, if at block 322 the controller 202 identifies slippage or spinning even after adjustment of the torque output to a value below the torque limit, the controller 202 further adjusts the torque output. In some embodiments, if at block 322 the controller 202 identifies slippage or spinning even after adjustment of the torque output to a value below the torque limit, the controller 202 may adjust the maximum value of the amount of torque delivered the ground engaging mechanisms.

In some embodiments, the controller 202 may increase the torque delivered to the ground engaging mechanisms 31, 32 if the controller 202 determines that: (i) the work machine 10 is in the slip zone, and (ii) the sensed ratio does not vary from the expected ratio by more than the established value. For example, each additional time the work machine 10 is in the slip zone, the controller 202 may adjust the torque delivered to the ground engaging mechanisms 31, 32 by lesser amounts (either increases or decreases) to optimize torque delivery without inducing slippage or spinning of the ground engaging mechanisms 31, 32.

In some embodiments, the controller 202 receives (e.g., from the at least one location sensor 214) an indication of the location (e.g., current location) of the work machine 10, such as the location of the work machine 10 within the worksite. In such embodiments, the controller 202 compares the location of the work machine 10 to a zone of interest that is not determined based on the speed of the work machine 10 and the rotational speed of one or more ground engaging mechanisms 31, 32. For example, in some embodiments, data indicative of the zone of interest is received by the controller 202 from the user interface 208 and stored in the memory 204. In some instances, the zone of interest may be a location including sand or other terrain where slippage of the ground engaging mechanisms 31, 32 is likely to occur. In any event, in response to determining that the work machine 10 is in the zone of interest, the controller 202 sends a signal to at least one of the power source 30 and the drivetrain 35 to adjust the torque delivered to the ground engaging mechanisms 31, 32. In the illustrative embodiment, the controller 202 causes adjustment of the torque delivered to the ground engaging mechanisms 31, 32 to an amount below a maximum value for such torque, which is associated with the zone of interest.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A work machine for loading material in a worksite, comprising:
a power source configured to provide torque;
a ground engaging mechanism configured to rotate to move the work machine along a ground surface;
a drivetrain coupled to the power source and to the ground engaging mechanism, the drivetrain configured to deliver torque from the power source to the ground engaging mechanism to drive rotation of the ground engaging mechanism;
a work machine speed sensor configured to measure the speed of the work machine moving along the ground surface;
a wheel speed sensor configured to measure the rotational speed of the ground engaging mechanism;
a controller operatively coupled to the wheel speed sensor and the work machine speed sensor and configured to receive a first signal from the work machine speed sensor indicative of the speed of the work machine moving along the ground surface and a second signal from the wheel speed sensor indicative of the rotational speed of the ground engaging mechanism;
wherein the controller is configured to adjust the torque delivered to the ground engaging mechanism based on the first signal and the second signal.

2. The work machine of claim 1, wherein the controller is configured to set a maximum value for the torque delivered to the ground engaging mechanism based on the first signal and the second signal.

3. The work machine of claim 1, wherein the controller is configured to compare a sensed ratio, which is comprised of the first signal relative to the second signal, to an expected ratio; and
wherein if a difference between the expected ratio and the sensed ratio exceeds an established value, the controller is configured to set a maximum value for the torque delivered to the ground engaging mechanism.

4. The work machine of claim 3, wherein the maximum value for the torque delivered to the ground engaging mechanism is less than the amount of torque being delivered to the ground engaging mechanism when the difference between the expected ratio and the sensed ratio exceeds the established value.

5. The work machine of claim 1, further comprising:
a location sensor operatively coupled to the controller;
wherein the location sensor is configured to send one or more third signals to the controller indicative of the location of the work machine in the worksite.

6. The work machine of claim 5, wherein the controller is configured to adjust the torque delivered to the ground engaging mechanism based on the one or more third signals.

7. The work machine of claim 5, wherein the controller is configured to compare a sensed ratio, which is comprised of the first signal relative to the second signal, to an expected ratio; and
wherein, if a difference between the expected ratio and the sensed ratio exceeds an established value, the controller is configured to set, for the location of the work machine in the worksite, a maximum value for the torque delivered to the ground engaging mechanism.

8. The work machine of claim 5, wherein the controller is configured to compare a sensed ratio, which is comprised of the first signal relative to the second signal, to an expected ratio; and
wherein, if a difference between the expected ratio and the sensed ratio exceeds an established value, the controller is configured to designate, as a slip zone, the location of the work machine in the worksite.

9. The work machine of claim 8, wherein the controller is configured to compare the location of the work machine to the slip zone to determine when the work machine is in the slip zone; and
wherein the controller is configured to adjust the torque delivered to the ground engaging mechanism in response to determining that the work machine is in the slip zone.

10. The work machine of claim 9, wherein the controller is configured to decrease the torque delivered to the ground engaging mechanism in response to determining that the work machine is in the slip zone.

11. The work machine of claim 1, wherein the controller is configured to decrease the torque delivered to the ground engaging mechanism based on the first signal and the second signal.

12. The work machine of claim 9, wherein the controller is configured to adjust the torque delivered to the ground engaging mechanism by a first amount in response to determining that the work machine is in the slip zone;
wherein the controller is configured to determine that the work machine is in the slip zone an additional time based on the one or more third signals; and
wherein the controller is configured to adjust the torque delivered to the ground engaging mechanism by an amount lesser than the first amount in response to determining that the work machine is in the slip zone an additional time.

13. The work machine of claim 12, wherein, in response to determining that the work machine is in the slip zone an additional time, the controller is configured to decrease the torque delivered to the ground engaging mechanism to adjust the torque delivered to the ground engaging mechanism by the amount lesser than the first amount.

14. The work machine of claim 12, wherein, in response to determining that the work machine is in the slip zone an additional time, the controller is configured to increase the torque delivered to the ground engaging mechanism to adjust the torque delivered to the ground engaging mechanism by the amount lesser than the first amount.

15. The work machine of claim 1, wherein the controller is configured to compare a sensed ratio, which comprises a measured speed of the work machine moving along the ground surface relative to a measured rotational speed of the ground engaging mechanism, to an expected ratio;
wherein, if a difference between the expected ratio and the sensed ratio exceeds an established value, the controller is configured to designate, as a slip zone, a current location of the work machine in the worksite; and
wherein each additional time the work machine is in the slip zone, the controller is configured to compare the sensed ratio to the expected ratio.

16. A work machine for loading material in a worksite, comprising:
a power source configured to provide torque;
a ground engaging mechanism configured to rotate to move the work machine along a ground surface;
a drivetrain coupled to the power source and to the ground engaging mechanism, the drivetrain configured to deliver torque from the power source to the ground engaging mechanism to drive rotation of the ground engaging mechanism;
a work machine speed sensor configured to measure the speed of the work machine moving along the ground surface;
a wheel speed sensor configured to measure the rotational speed of the ground engaging mechanism; and
a controller operatively coupled to the wheel speed sensor and the work machine sensor and configured to receive a first signal from the work machine speed sensor indicative of the speed of the work machine moving along the ground surface and a second signal from the wheel speed sensor indicative of the rotational speed of the ground engaging mechanism;
wherein the controller is configured to set a maximum value for the torque delivered to the ground engaging mechanism based on the first signal and the second signal.

17. The work machine of claim 16, wherein the controller is configured to compare a sensed ratio, which is comprised of the first signal relative to the second signal, to an expected ratio; and
wherein, if a difference between the expected ratio and the sensed ratio exceeds an established value, the controller is configured to set, for a current location of the work machine in the worksite, the maximum value for the torque delivered to the ground engaging mechanism.

18. The work machine of claim 17, wherein the maximum value for the torque delivered to the ground engaging mechanism is less than the torque delivered to the ground engaging mechanism when the difference between the expected ratio and the sensed ratio exceeds the established value.

19. A method of adjusting torque of a work machine used for loading material in a worksite, comprising:
measuring a speed of the work machine moving along a ground surface;
measuring a rotational speed of a ground engaging mechanism configured to move the work machine along the ground surface;
receiving, via a controller, a first signal indicative of the speed of the work machine moving along the ground surface and a second signal indicative of the rotational speed of the ground engaging mechanism;
adjusting, via the controller, a torque delivered to the ground engaging mechanism based on the first signal and the second signal.

20. The method of claim 19, further comprising:
measuring a location of the work machine in the worksite;
receiving, via the controller, a third signal indicative of the location of the work machine in the worksite; and
adjusting the torque delivered to the ground engaging mechanism further based on the third signal.
